(19) United States
(12) Patent Application Publication
(10) Pub. No.: US 2026/0217086 A1
(43) Pub. Date: Jul. 30, 2026

(54) ELECTRIC VEHICLE

(71) Applicant: BOMBARDIER RECREATIONAL PRODUCTS INC., Valcourt (CA)

(72) Inventors: Nicolas LABERGE, Magog (CA); Erik Carl Gustav EVERS, Bromont (CA); Andre COTE, Hatley (CA); Thomas UHR, Bromont (CA)

(21) Appl. No.: 19/152,126

(22) PCT Filed: Mar. 15, 2024
(86) PCT No.: PCT/IB2024/052539

§ 371 Date: Jul. 30, 2025

Related U.S. Application Data
(60) Provisional application No. 63/490,572, filed on Mar. 16, 2023.

(51) Int. Cl. B60H 1/00

(52) U.S. Cl. CPC B60H 1/0055; B60H 1/00385; B60H 1/00564

(57) ABSTRACT

A vehicle including a frame and a vehicle body; a passenger compartment defined at least in part by the vehicle body; at least one motor supported by the frame; a plurality of wheels rotationally connected to the frame; a dashboard assembly connected to the frame, the dashboard assembly being at least partially disposed in the passenger compartment. The dashboard assembly includes at least one dashboard body forming at least a portion of a passenger compartment dashboard surface, a plurality of air-flow passages being defined in the at least one dashboard body; and a heating, ventilation, and air conditioning (HVAC) unit connected to the at least one dashboard body and fluidly connected to the plurality of air-flow passages, the HVAC unit being arranged to provide environmental air flow to the passenger compartment via the plurality of air-flow passages.

### CROSS-REFERENCE

The present application claims priority to U.S. Provisional Patent Application No. 63/490,572, entitled “Electric Vehicle,” filed Mar. 16, 2023, the entirety of which is incorporated by reference herein.

### FIELD OF TECHNOLOGY

The present technology relates to vehicles, more specifically to electric automobiles.

### BACKGROUND

Passenger vehicles conventionally have dashboard assemblies formed from an outer molded plastic panel mounted to molded plastic structural elements behind. Heating and cooling ducts are formed from separately molded plastic components that connect a Heating Ventilation and Air Conditioning (HVAC) unit to air vents that direct air into the passenger compartment. The passenger facing surface is generally formed by a separate panel or collection of aesthetic panels to be connected to the main molded plastic structural elements.

Such constructions can be heavy and costly to construct, as it includes the fabrication of many components and then the assembly of said components together. The full construction can also be voluminous in some constructions, as piping or connections may be required through the vehicle for the HVAC unit. In small vehicles, both weight and volume minimization are especially sought after.

There thus remains a desire for vehicle arrangements addressing at least some of the above-described disadvantages.

### SUMMARY

It is an object of the present technology to ameliorate at least some of the inconveniences present in the prior art.

According to one aspect of the present technology, there is provided a dashboard assembly for a vehicle. The dashboard assembly includes a dashboard body forming a part of the passenger compartment interior and a heating, ventilation, and air conditioning (HVAC) unit connected to the body. The dashboard body and the HVAC unit housing are formed from expanded polymer foam, in which air flow passages are defined. A passenger-facing surface of the dashboard body is molded to a finish to provide an aesthetic surface, thereby removing the requirement for an additional aesthetic panel to be supplied. By forming the dashboard assembly from expanded polymer, both air ducting and the aesthetic surfaces are created directly with the main dashboard structure. By combining these features in one component, there can be significant cost savings due to decreased material costs, product weight, reduced number of components (eliminating fasteners), and reduced fabrication labor. Air passages for providing air to the passenger compartment are divided into arrays of outlets, thus providing broadly distributed (but small) air outlets. In additional to the aesthetic appeal of eliminating relatively large ducting in the dashboard surface, air may also be more widely delivered, thereby improving uniformity of heating and cooling. It is also noted that some expanded polymers, including for instance expanded polypropylene (EPP), have antimicrobial properties which can be advantageous for air ducting.

According to one aspect of the present technology, there is provided a vehicle including a frame; a vehicle body formed at least in part by the frame; a passenger compartment defined at least in part by the vehicle body; at least one motor supported by the frame; a plurality of wheels rotationally connected to the frame, at least one wheel of the plurality of wheels being operatively connected to the at least one motor; a dashboard assembly connected to the frame, the dashboard assembly being at least partially disposed in the passenger compartment, the dashboard assembly including: at least one dashboard body forming at least a portion of a passenger compartment dashboard surface, a plurality of air-flow passages being defined in the at least one dashboard body; and a heating, ventilation, and air conditioning (HVAC) unit connected to the at least one dashboard body and fluidly connected to the plurality of air-flow passages, the HVAC unit being arranged to provide environmental air flow to the passenger compartment via the plurality of air-flow passages.

In some embodiments, the plurality of air-flow passages includes an array of defroster ducts defined along a forward portion of the at least one dashboard body.

In some embodiments, the plurality of air-flow passages includes: a first array of demister ducts defined along a left side portion of the at least one dashboard body; and a second array of demister ducts defined along a right side portion of the at least one dashboard body.

In some embodiments, the plurality of air-flow passages includes an array of compartment ducts defined along at least a rear side portion of the at least one dashboard body.

In some embodiments, the HVAC unit includes an HVAC housing connected to a bottom side portion of the at least one dashboard body; and a plurality of HVAC components disposed in the HVAC housing, the plurality of HVAC components being arranged for managing and conditioning air flow into the passenger compartment via the plurality of air-flow passages.

In some embodiments, the HVAC housing and the at least one dashboard body are formed from an expanded polymer.

In some embodiments, the plurality of HVAC components includes a fan; a cooling element; a heating element; and a temperature-control valve.

In some embodiments, during operation of the HVAC unit, intake air is pulled into the HVAC housing by the fan; air flows through the cooling element; in response to the temperature-control valve being in a first position, air is directed out of the HVAC housing and into the at least one dashboard body; and in response to the temperature-control valve being in a second position, air flows through the heating element and is subsequently directed out of the HVAC housing and into the at least one dashboard body.

In some embodiments, the plurality of HVAC components further includes a filter disposed upstream from the fan for filtering intake air entering the HVAC housing.

In some embodiments, the plurality of HVAC components further includes an output valve for managing air flow from the HVAC housing to the at least one dashboard body.

In some embodiments, during operation of the HVAC unit, intake air is pulled into the HVAC housing by the fan; air flows through the cooling element; in response to the temperature-control valve being in a first position, air is directed toward the output valve; in response to the temperature-control valve being in a second position, air flows through the heating element and is subsequently directed toward the output valve; in response to the output valve being in a first position, air is directed into a first subset of the plurality of air-flow passages; and in response to the output valve being in a second position, air is directed into a second subset of the plurality of air-flow passages.

In some embodiments, the dashboard assembly further includes an air-intake conduit fluidly connected to the HVAC unit.

In some embodiments, the dashboard assembly further includes a filter disposed between the air-intake conduit and the at least one dashboard body.

In some embodiments, the vehicle further includes a front windshield; and the plurality of air-flow passages includes an array of defroster ducts; outlets of the array of defroster ducts are defined in a forward portion of the passenger compartment dashboard surface; and the outlets of the array of defroster ducts are positioned and arranged to deliver air flow to an interior side of the front windshield.

In some embodiments, the array of defroster ducts extends laterally across at least a majority of the at least one dashboard body.

In some embodiments, the at least one dashboard body is formed from an expanded polymer.

In some embodiments, the at least one dashboard body is formed from expanded polypropylene (EPP).

In some embodiments, the at least one dashboard body is formed from one of: expanded polystyrene; and expanded polyurethane.

In some embodiments, the plurality of air-flow passages and the passenger compartment dashboard surface are uniquely defined and formed by the expanded polymer of the at least one dashboard body.

In some embodiments, the at least one dashboard body includes a center portion extending laterally across the passenger compartment; a right side portion extending rearward from a right end of the center portion; and a left side portion extending rearward from a left end of the center portion.

In some embodiments, the vehicle further includes a left side door pivotally connected to the frame, and a right side door pivotally connected to the frame; and the plurality of air-flow passages includes a left side array of demister ducts; outlets of the left side array of demister ducts are defined in a left side portion of the passenger compartment dashboard surface; the outlets of the left side array of demister ducts are positioned and arranged to deliver air flow near an interior side of the left side door; the plurality of air-flow passages includes a right side array of demister ducts; outlets of the right side array of demister ducts are defined in a right side portion of the passenger compartment dashboard surface; and the outlets of the right side array of demister ducts are positioned and arranged to deliver air flow near an interior side of the right side door.

In some embodiments, the plurality of air-flow passages includes an array of compartment ducts; outlets of the array of compartment ducts are defined in a rear side portion of the passenger compartment dashboard surface; the outlet of the array of compartment ducts are positioned and arranged to deliver air flow to the passenger compartment.

In some embodiments, the outlets of the array of compartment ducts are disposed over a width of the passenger compartment.

In some embodiments, the vehicle is an automobile; and the plurality of wheels includes two front wheels and two rear wheels.

In some embodiments, the at least one motor is at least one electric motor; and further including a battery system supported by the frame and electrically connected to the electric motor.

In some embodiments, the frame includes a chassis, and an upper body frame connected to and extending upward from the chassis; and the dashboard assembly is connected to the upper body frame form.

In some embodiments, the chassis is a skateboard chassis including the at least one electric motor, and the battery system.

In some embodiments, the HVAC unit is powered by the battery system.

In some embodiments, the vehicle further includes a steering column operatively connected to the plurality of wheels, the steering column extending rearward below the dashboard assembly.

In some embodiments, the at least one dashboard body has a generally flattened-U shape.

In some embodiments, the at least one dashboard body defines a majority of the passenger compartment dashboard surface, the passenger compartment dashboard surface being visible within the passenger compartment to a user of the vehicle.

For the purposes of the present application, terms related to spatial orientation such as forward, rearward, front, rear, upper, lower, left, and right, are as they would normally be understood by a driver of the vehicle sitting therein in a normal driving position with the vehicle being steered in a straight ahead direction. Terms related to spatial orientation when describing or referring to components or sub-assemblies of the vehicle, separately from the vehicle, should be understood as they would be understood when these components or sub-assemblies are mounted to the vehicle, unless specified otherwise in this application.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an electric automobile according to a non-limiting embodiment of the present technology;

FIG. 2 is a top plan view of the vehicle of FIG. 1;

FIG. 3 is a perspective, schematic view of a chassis of the vehicle of FIG. 1;

FIG. 4 is a top, rear, left side perspective view of portions of an upper body frame of the vehicle of FIG. 1;

FIG. 5 is a top, rear, left side perspective view of portions of a passenger compartment of the vehicle of FIG. 1;

FIG. 6 is a top plan view of the passenger compartment portions of FIG. 5;

FIG. 7 is a top, front, right side perspective view of a dashboard assembly of the vehicle of FIG. 1;

FIG. 8 is a top, rear, right side perspective view of the dashboard assembly of FIG. 7;

FIG. 9 is a top plan view of the dashboard assembly of FIG. 7;

FIG. 10 is a bottom plan view of the dashboard assembly of FIG. 7;

FIG. 11 is a bottom, rear, left side perspective view of a dashboard body of the dashboard assembly of FIG. 7;

FIG. 12 is a bottom plan view of the dashboard body of FIG. 11;

FIG. 13 is a top, front, left side perspective view of a heating, ventilation, and air conditioning (HVAC) unit of the dashboard assembly of FIG. 7, with a portion of a housing of the HVAC unit having been removed to illustrate internal components;

FIG. 14 is a cross-sectional view of the dashboard assembly of FIG. 7, taken along line 14-14 of FIG. 9;

FIG. 15 is a cross-sectional view of the dashboard assembly of FIG. 7, taken along line 15-15 of FIG. 9;

FIG. 16 is a front side elevation view of portions of the HVAC unit of FIG. 13 and a filter of the dashboard assembly of FIG. 7, with a portion of the housing having been removed to illustrate internal components; and

FIG. 17 is a front side elevation view of the portions of the HVAC unit of FIG. 16, with two valves of the HVAC being in a different second position, with a portion of the housing having been removed to illustrate internal components.

It should be noted that, unless otherwise explicitly specified herein, the drawings are not necessarily to scale.

### DETAILED DESCRIPTION

The vehicle 100 illustrated herein is a two-door electric automobile 100. It is contemplated that vehicles according to the present technology could vary by a plurality of vehicle characteristics. These vehicle characteristics could include, but are not limited to, a car type (sedan, coupe, etc.), tire type, a wheelbase, rear storage access (hatch back or trunk).

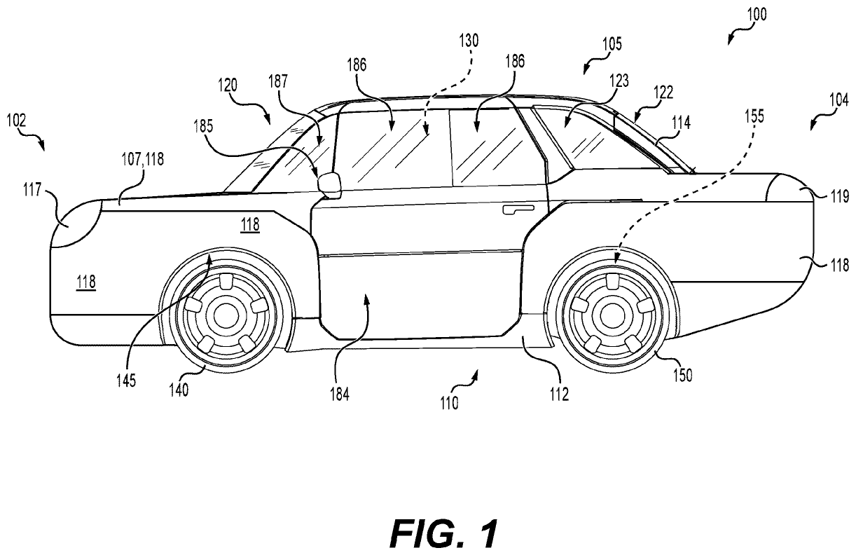

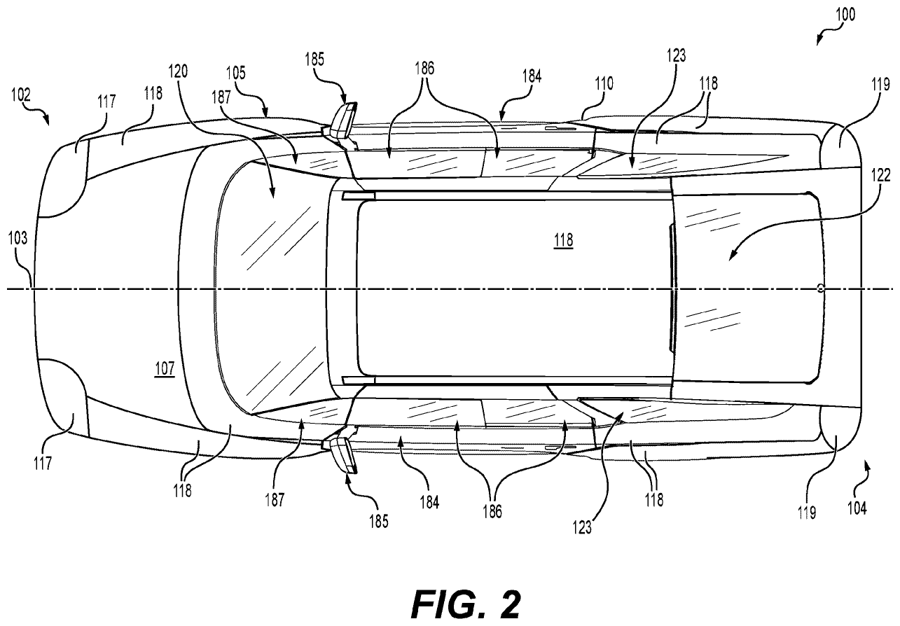

The general features of an electric automobile 100, referred to herein as the vehicle 100, will be described with respect to FIGS. 1 and 2. The vehicle 100 has a front end 102, a rear end 104, and a longitudinal center plane 103 defined consistently with the forward travel direction of the vehicle 100. The vehicle 100 has a vehicle body 105 defining the form and extent of the vehicle 100. In the present embodiment, the vehicle 100 is illustrated with a sedan-style vehicle body 105. It is contemplated that in different embodiments implementing the present technology, the vehicle body 105 could be of a variety of types, including but not limited to: hatchback, sports utility vehicle (SUV), multi-purpose vehicle (MPV), city car style, coupe, compact, and subcompact.

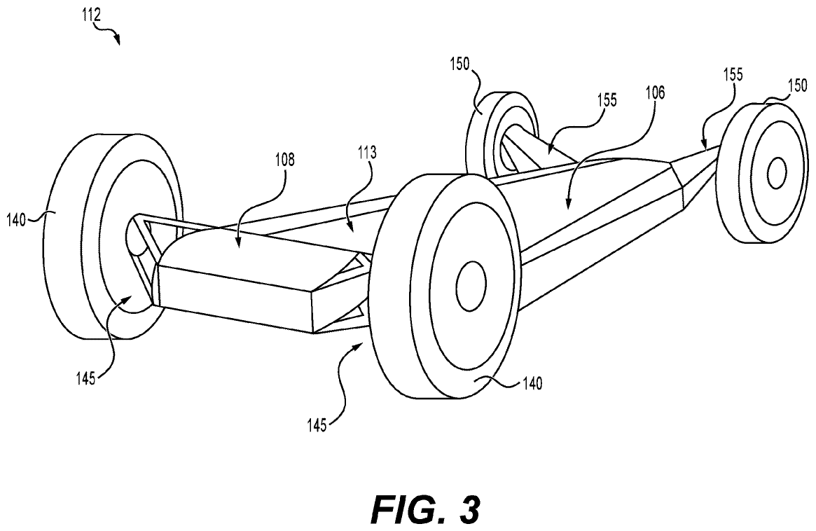

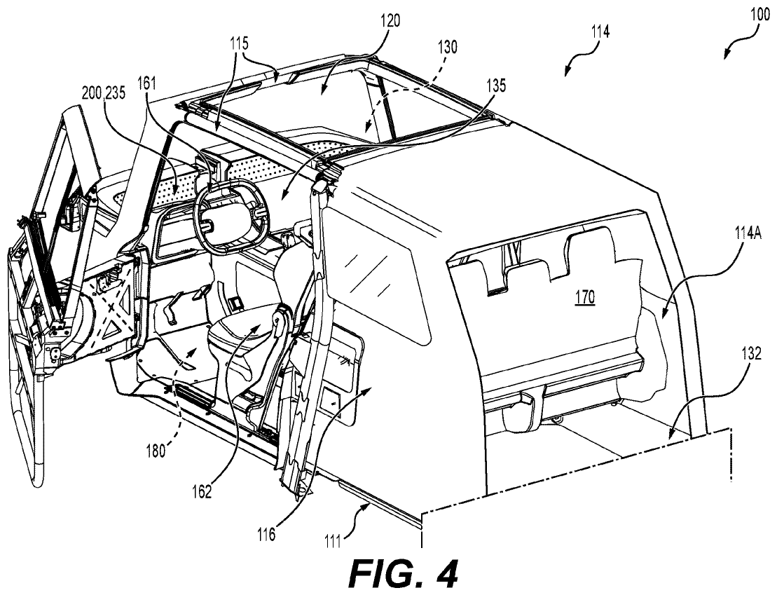

With additional reference to FIGS. 3 and 4, the vehicle 100 has a frame 110, also referred to as a frame assembly 110. The frame 110 supports and forms, in part, the vehicle body 105. By the present technology, the frame 110 is formed from two parts: a lower base structure provided by a rolling platform type chassis 112 (FIG. 3) and an upper body frame 114 connected to and extending from the chassis 112 (FIG. 4).

The chassis 112 forms the rigid base structure of the frame 110. The rolling platform type chassis 112 has a generally horizontal structure to which the vehicle wheels are connected. Specifically, the vehicle 100 has two front wheels 140 connected to a front of the chassis 112 by front suspension assemblies 145 (shown schematically in FIG. 1). The vehicle 100 also includes two rear wheels 150 connected to a rear of the chassis 112 by rear suspension assemblies 155 (shown schematically in FIG. 1).

In the present embodiment, the rolling platform chassis 112 is specifically an electric-vehicle skateboard-type chassis 112. The chassis 112 includes a battery system 106 for providing power to the vehicle 100. The battery system 106 is packaged into a central portion of the chassis 112. The battery system 106 thus extends across a generally horizontal plane on a bottom side portion of the vehicle 100. Without limitation, it is contemplated that the battery system 106 could include, but is not limited to: batteries and/or battery cells, a charger, an inverter, etc.

The skateboard chassis 112 also includes an electric motor 108 connected thereto. The motor 108 is disposed in a forward portion of the chassis 112 for driving the front wheels 140. The chassis 112 includes a drivetrain (not shown) connecting the motor 108 to the wheels 140. It is contemplated that the motor 108 could be disposed in a rearward portion of the chassis 112 for driving the rear wheels 150. It is further contemplated that the chassis 112 could include two motors, one for driving each pair of wheels 140, 150. It is further contemplated that a drivetrain connecting the forwardly disposed motor 108 to the rear wheels 150 could be included in some embodiments. It is further contemplated that four motors could be provided, one for each wheel, including but not limited to direct-drive in-wheel type motors, also referred to as “hub motors”.

The motor 108 and the battery system 106 are packaged into the skateboard chassis 112, such that the structure of the chassis 112, the motor 108, and the battery system 106 form a unit. The battery system 106 is operatively connected to the motor 108 for providing power thereto, electrical connections (not shown) being encased in the body of the chassis 112.

As shown in FIG. 4, the upper body frame 114 is formed from both a plurality of hollow frame tubes 115 and a unibody portion 116. It is contemplated that the upper body frame 114 could be formed entirely from a unibody or entirely from frame tubes 115. It is also contemplated that multiple unibody type structures could be included in the upper body frame 114.

The upper body frame 114 is connected to and extends upward from a top surface 113 of the chassis 112. Specifically, a generally flat bottom portion 111 of the upper body frame 114 is disposed on the generally flat chassis top surface 113. The bottom portion 111 is specifically defined by the unibody portion 116, although a separate floor structure could be included in some embodiments. In the present embodiment, the upper body frame 114 is welded to the chassis 112, but different methods of connecting the chassis 112 and the upper body frame 114 are contemplated, such as bolts and adhesives. In the illustrated embodiment, the vehicle 100 further includes a forward subframe (not shown) and a rearward subframe (not shown) defining forward and rearward portions of the vehicle body 105.

Returning to FIGS. 1 and 2, the vehicle 100 further includes body panels 118 for defining, in part, the vehicle body 105. The body panels 118 are connected to the frame 110, specifically to the upper body frame 114, as well as to the forward and rearward subframes. The panels 118 help protect the internal components of the vehicle 100, provide aerodynamic features, and provide some of the aesthetic features of the vehicle 100.

Forwardly disposed panels 118 define two apertures inside which two front illumination assemblies 117 of the vehicle 100 are disposed. The front illumination assemblies 117 include front headlamps, front turn indicator lamps, and front high beams (not separately identified). Depending on the embodiment, additional or alternative front lights could be included in the front illumination assemblies 117. It is also contemplated that the panels 118 could define additional apertures for receiving additional separate front illumination or reflective components.

Rearwardly disposed panels 118 define two apertures inside which two rear illumination assemblies 119 of the vehicle 100 are disposed. The rear illumination assemblies 119 include brake lights, rear turn indicator lamps, and reverse indicator lamps (not separately identified). Depending on the embodiment, additional or alternative rear lights could be included in the rear illumination assemblies 119. It is also contemplated that the panels 118 could define additional apertures for receiving additional separate rear illumination or reflective components.

The vehicle body 105 also includes a front hood 107 pivotally connected to the frame 110 for selectively providing access to at least some forward vehicle components. The vehicle body 105 also includes a rear trunk door 109 for selectively closing a rear trunk storage space (not shown). Depending on the particular embodiment, including for example vehicle body type, the hood 107 and/or the trunk door 109 could have different forms. It is also contemplated that the hood 107 and/or the trunk door 109 could be replaced by immovable body panels 118 in some embodiments. It is further contemplated that other storage spaces closed by respective movable panels, instead of or in addition to the front hood 107 and/or rear trunk door 109, could be provided in some embodiments.

The vehicle body 105 includes a front windshield 120 extending laterally across a forward portion of the upper body frame 114. The vehicle body 105 also includes a rear window 122 extending laterally across a rearward portion of the upper body frame 114. The vehicle body 105 further includes two rear side windows 123, one window 123 being disposed on each side of the vehicle 100. Depending on the particular car type of a given embodiment of the vehicle 100, the rear side windows 123 could be omitted in some cases. It is also contemplated that additional side windows could be included in different embodiments.

The vehicle body 105 also defines therein two openings 180 through which a driver or passenger can enter or exit the vehicle 100. A right side opening 180 is defined in a right side of the vehicle body 105 and a left side opening 180 is defined in a left side of the vehicle body 105. The right side opening 180 is selectively closed by a right side door 184 movably connected to a right side the vehicle body 105. The left side opening 180 is selectively closed by a left side door 184 movably connected to a left side the vehicle body 105.

The door 184 also includes two windows 186. The forward most door window 186 is selectively moveable in a generally vertical direction. It is contemplated that neither or both windows 186 could be moveable, depending on the specific embodiment. It is also contemplated that the door 184 could include more or fewer windows. The door 184 also includes a side mirror 185 extending generally lateral outward from the exterior side of the door 184.

The vehicle 100 includes a passenger compartment 130, inside which passengers (including a driver) of the vehicle 100 are situated during operation of the vehicle 100. The passenger compartment 130 is defined by the vehicle body 105. Specifically, the passenger compartment 130 is defined by an interior surface of the upper body frame 114 and the body panels 118 connected thereto. While not illustrated explicitly, at least some portions of the interior surface of the vehicle body 105 defining the passenger compartment 130 is generally covered with surface finishing materials, including but not limited to: carpeting, plastic and/or wood paneling, liner fabric, and insulating materials.

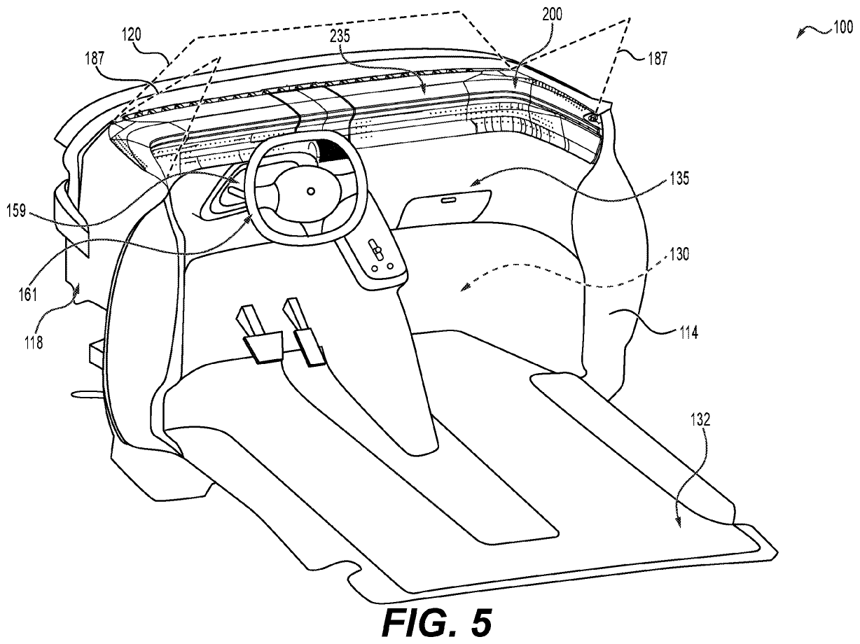

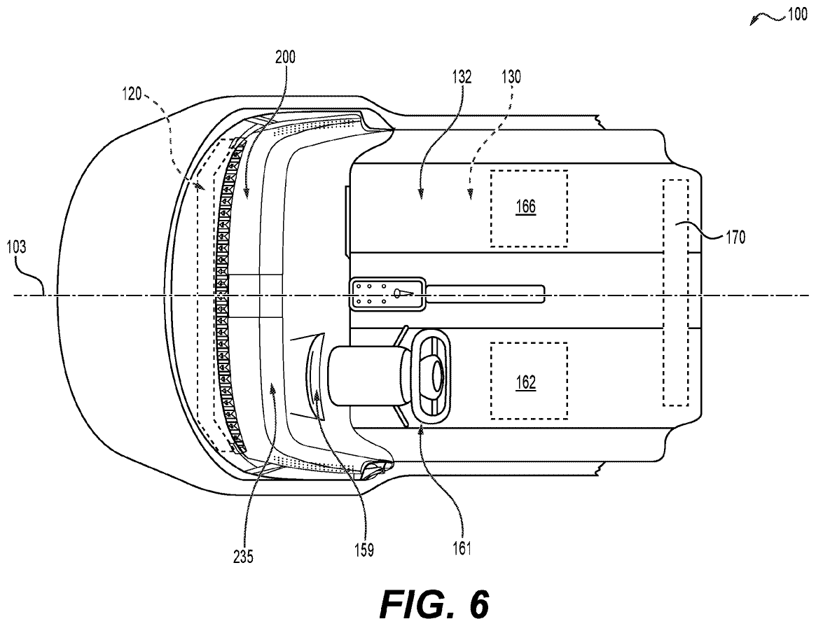

A floor 132 of the passenger compartment 130 is formed by a top surface of the bottom portion 111 of the upper body frame 114 (see also FIGS. 5 and 6). Although not specifically illustrated, it is contemplated that the floor 132 defined by the bottom portion 111 is generally covered by noise and/or heat insulating material and automotive carpeting. As is mentioned above, the bottom portion 111 is formed over the top surface 113 of the skateboard chassis 112 and is generally flat. The floor 132 of the passenger compartment 130 is similarly generally flat along a longitudinal length of the passenger compartment 130, being formed upon the bottom portion 111 of the upper frame body 114.

As is shown schematically in FIG. 6, the vehicle 100 includes two front seats disposed in the passenger compartment 130. Specifically, the vehicle 100 includes a driver seat 162 (see also FIG. 4) and a front passenger seat 166. In the present embodiment, the driver seat 162 is disposed on the left side of the center plane 103 and the passenger seat 166 is disposed on the right side of the center plane 103. It is contemplated, however, that the driver seat 162 could be disposed on the right side of the vehicle 100 and that the passenger seat 166 could be disposed on the left side of the vehicle 100.

The vehicle 100 further includes rear seating, also referred to as a second row of seating, illustrated in FIGS. 4 and 6. In the illustrated embodiment, the vehicle 100 includes a rear bench seat 170 disposed in the passenger compartment 130. The rear bench seat 170 is disposed rearward of the front seats 162, 166. The rear bench seat 170 configured to seat a plurality of passengers. In the illustrated embodiment, the rear bench seat 170 is arranged to seat three passengers. In at least some embodiments, the rear bench seat 170 could be configured to receive and seat two passengers. In at least some embodiments it is contemplated that the rear bench seat 170 could be replaced with two or three individual rear seats.

As is shown in FIG. 4, the rear bench seat 170 extends laterally over at least a majority of a width 133 of the passenger compartment 130. The rear bench seat 170 is supported by the upper body frame 114, specifically lateral, generally vertically extending side portions 114A (walls 114A) of the upper body frame 114. Lateral ends 174 of the rear bench seat 170 are connected to opposite lateral sides 114A of the upper body frame 114. It is contemplated that the rear bench seat 170, or other implementations of rear seating, could be differently installed in the passenger compartment 130, for example using vertically extending seating legs connected to the floor 132 of the passenger compartment 130.

The vehicle 100 includes additional components disposed in the passenger compartment 130 for operation by and accommodation of passengers of the vehicle 100. A steering wheel 161 is disposed in front of the driver seat 162. The steering wheel 161 is used to turn the front wheels 140 to steer the vehicle 100 via a steering assembly (not shown). A driver display 159, including various displays and gauges, is disposed above and forward the steering wheel 161 to provide information to the driver regarding the operating conditions of the vehicle 100. Examples of displays and gauges in the driver display 159 include, but are not limited to, a speedometer, a battery state of charge, a vehicle range, and a vehicle drive mode (park, drive, reverse), as well as symbols indicating the activation of turn signals, head lights, a parking brake, a regenerative braking level and various fault conditions (for example, high battery temperature, low battery, limited power, and electrical fault). Additional components are contemplated to be included in the passenger compartment 130, including but not limited to: a glove box, console(s), a rear-view mirror, seat belts, navigational systems, heating systems, sound systems, storage compartments, and safety features.

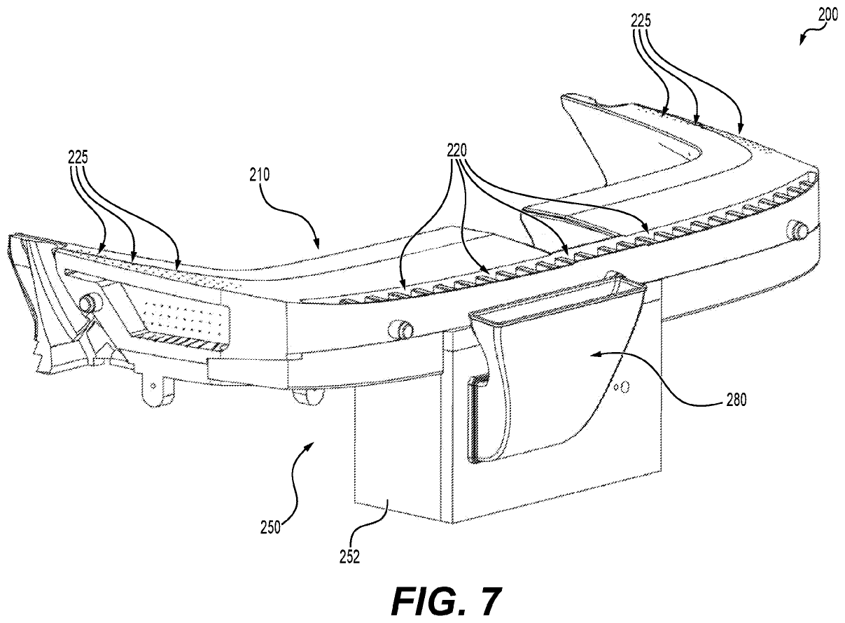

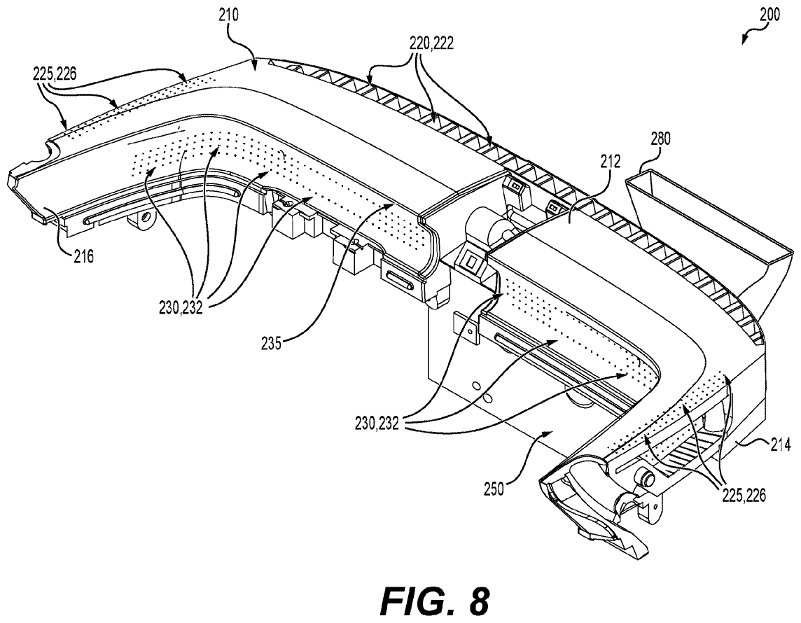

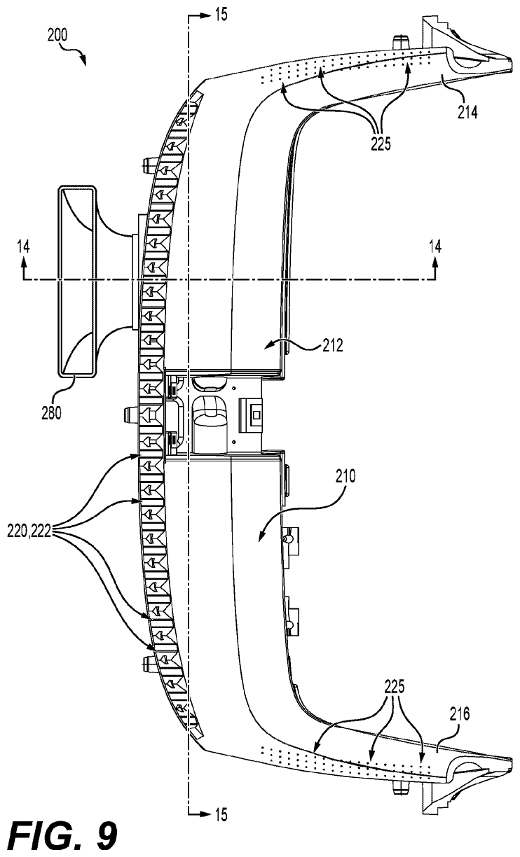

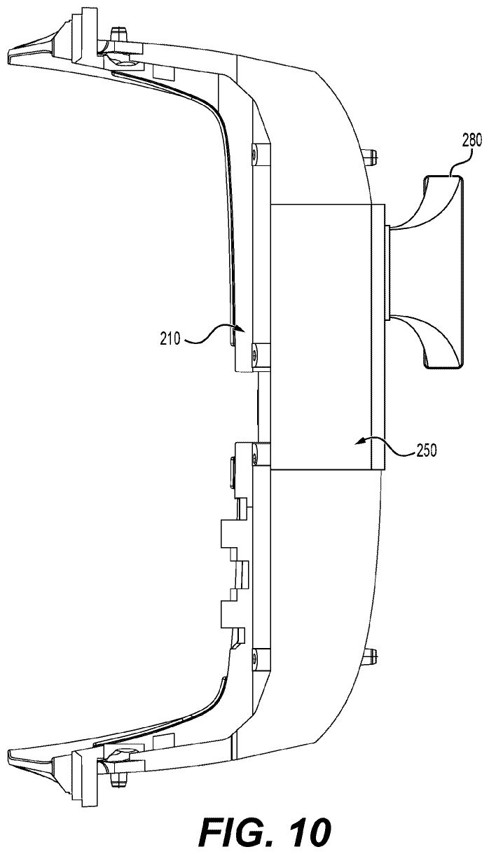

With additional reference to FIGS. 7 to 10, the vehicle 100 further includes a dashboard assembly 200 partially defining and partially disposed in the passenger compartment 130. The dashboard assembly 200, also referred to herein as the assembly 200, is connected to the frame 110. In the present embodiment, the assembly 200 is specifically fastened to the upper body frame 114, although different arrangements are contemplated. The assembly 200 is disposed forward of the front seats 162, 166 and forms a portion of the dash surface of the vehicle 100. Specifically, the assembly 200 is disposed generally forward of the steering wheel 161, and thus partially defines an interior surface of the vehicle 100 in the passenger compartment 130, as will be described in further detail below.

The assembly 200 includes a dashboard body 210 and a heating, ventilation, and air conditioning (HVAC) unit 250 connected to the dashboard body 210. Broadly, the dashboard body 210 is configured and arranged to deliver air for heating, cooling, and ventilation to the passenger compartment 130, while also forming portions of a dash surface 135 of the vehicle 100. Air distributed into the passenger compartment 130 by the dashboard body 210 is received from the HVAC unit 250, as will be described in additional detail below. The dashboard assembly 200 further includes an air-intake conduit 280 fluidly connected to the HVAC unit 250. The air-intake conduit 280 is arranged to direct air into the HVAC unit 250. An inlet 281 of the conduit 280 is arranged to receive ambient air from an exterior of the vehicle 100, directing air into the HVAC unit 250 through an outlet 282 of the conduit 280.

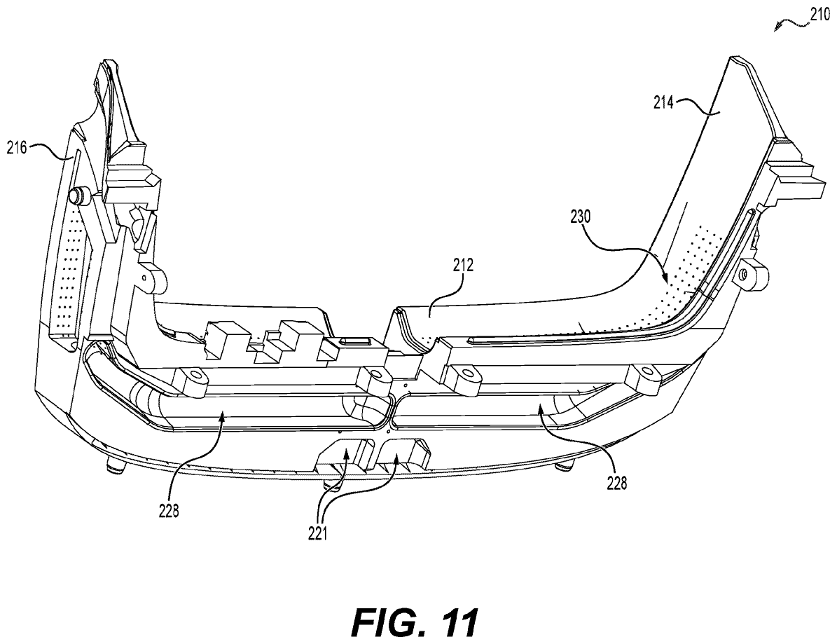

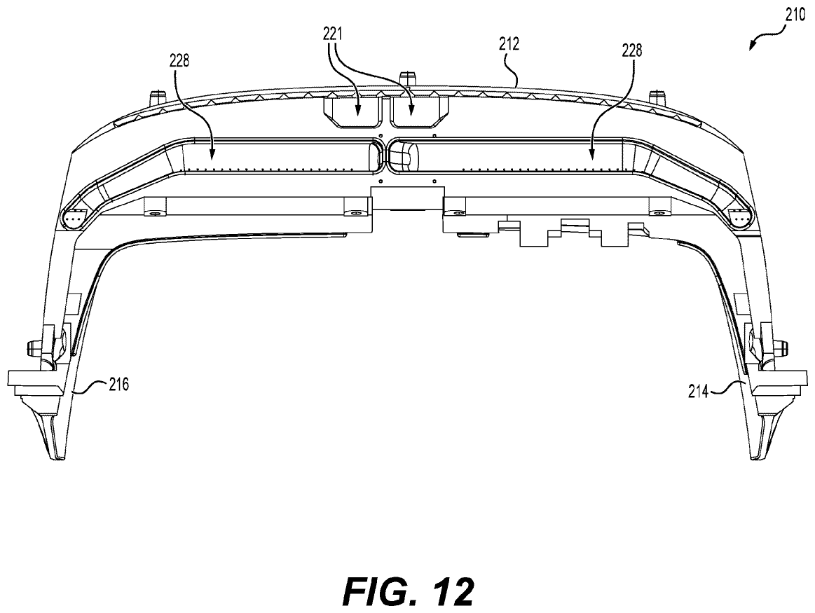

With additional reference to FIGS. 11 and 12, the dashboard body 210 has a generally flattened-U shape (as seen from above) such that the dashboard body 210 extends along an entirety of a front side of the passenger compartment 130 and along a portion of the right and left sides thereof. Specifically, the dashboard body 210 includes a center portion 212 extending laterally across the passenger compartment 130. A right side portion 214 extends rearward from a right end of the center portion 212 and a left side portion 216 extending rearward from a left end of the center portion 212.

The dashboard body 210 is formed from an expanded polymer. In the present embodiment, the dashboard body 210 is specifically formed from expanded polypropylene (EPP). It is also contemplated that different expended polymer could be used to form the dashboard body 210, including, but not limited to, expanded polystyrene and expanded polyurethane. While described herein as a single dashboard body 210, it is contemplated that the body 210 could be formed by separately formed pieces thereafter connected together (for example glued together).

As is mentioned above, a passenger facing side of the dashboard body 210 defines a portion of the dash surface 135. A passenger compartment dashboard surface 235 of the dash surface 135, i.e. a portion of the aesthetic interior surface of the vehicle 100, is formed directly by the expanded polymer of the dashboard body 210. In the illustrated embodiment, the dashboard body 120 defines a majority of the dashboard surface of the vehicle 100, with the passenger compartment dashboard surface 235 being visible within the passenger compartment 130 to a user of the vehicle 100. By providing the visible, aesthetic surface directly, the dashboard assembly 200 does not require an additional surface structure to be connected to the dashboard body 210, reducing complexity, cost, and weight compared to previous dashboard structures having both main body assemblies and aesthetic surface panels.

The dashboard body 210 has defined therein a plurality of airflow passages for conducting airflow from the HVAC unit 250 to the passenger compartment 130. In the present embodiment, the airflow passages are arranged in three groups: an array of defroster ducts 220 directing air toward an interior side of the front windshield 120, two arrays of demister ducts 225 directing air toward an interior side of the quarter glass windows 187, and an array of compartment ducts 230 directing air into the passenger compartment 130. It is contemplated that additional or alternative arrangements of passages could be defined in the dashboard body 210.

As the dashboard body 210 is formed from expanded polymer, the airflow passages 220, 225, 230 are directly formed in the body 210, specifically as voids extending through the body 210. Other than the passages 220, 225, 230, volume within the dashboard body 210 is generally filled by the expanded polymer, aiding in maintaining strength and rigidity of the dashboard body 210. As such, the airflow passages 220, 225, 230 and the passenger compartment dashboard surface 235 are uniquely defined and formed by the expanded polymer of the dashboard body 210.

The array of defroster ducts 220, also referred to as defroster passages 220, are defined along a forward portion of the dashboard body 210. The array of defroster ducts 220 extends laterally across at least a majority of the dashboard body 210, although different position and distribution of the ducts 220 is contemplated. In the illustrated embodiment, two inlets 221 forming a portion of the defroster ducts 220 are defined in a bottom side of the dashboard body 210. The defroster ducts 220 branch out from the inlets 221, with an array of outlets 222 defined in the forward portion of the passenger compartment dashboard surface 235. Two subsets of the ducts 220 thus intersect at their corresponding inlet 221 in the present embodiment. Depending on the particular embodiment, it is contemplated that the ducts 220 could be formed with more or fewer inlets and outlets. The outlets 222 of the array of defroster ducts 220 are positioned and arranged to deliver air flow to an interior side of the front windshield 120.

The two arrays of demister ducts 225, also referred to as demister passages 225, are arranged and configured to provide airflow to an interior quarter glass windows 187 for reducing side window fog. A first array of demister ducts 225 are defined along a top side of the left side body portion 216 for demisting the left side quarter glass window 187. A second array of demister ducts 225 are defined along the right side body portion 214. In the illustrated embodiment, inlets 228 forming a portion of each array of the demister ducts 225 are defined in a bottom side of the dashboard body 210. The inlets 228 are generally grooves extending laterally across the bottom side of the dashboard body 210, but different shapes and sized of inlets 228 are contemplated. The demister ducts 225 branch out from the inlets 228, with two arrays of outlets 226 defined in side portions of the passenger compartment dashboard surface 235. Depending on the particular embodiment, it is contemplated that the ducts 225 could be formed with more or fewer inlets and outlets.

The compartment ducts 230, also referred to as compartment passages 230, are defined along a rear side of the dashboard body 210, specifically along the passenger facing side of the center portion 212. The compartment ducts 230 are configured and arranged to direct air into the passenger compartment 130 in order to heat, cool, and/or provide fresh air (ventilation) to users of the vehicle 100. In the illustrated embodiment, the compartment ducts 230 are arranged on a general vertical surface portion of the dashboard body 210. It is contemplated that downward directing ducts or ducts in a bottom side could be included for providing heating and/or cooling to footwell areas of the vehicle 100 in some embodiments. In the illustrated embodiment, the inlets 228 also form a portion of each compartment duct 230. The compartment ducts 230 branch out from the inlets 228, with outlets 232 defined in the passenger compartment dashboard surface 235. In the present embodiment, the outlets 232 of the array of compartment ducts 230 are disposed over a width of the passenger compartment 130. Depending on the particular embodiment, it is contemplated that the ducts 230 could be formed with more or fewer inlets and outlets.

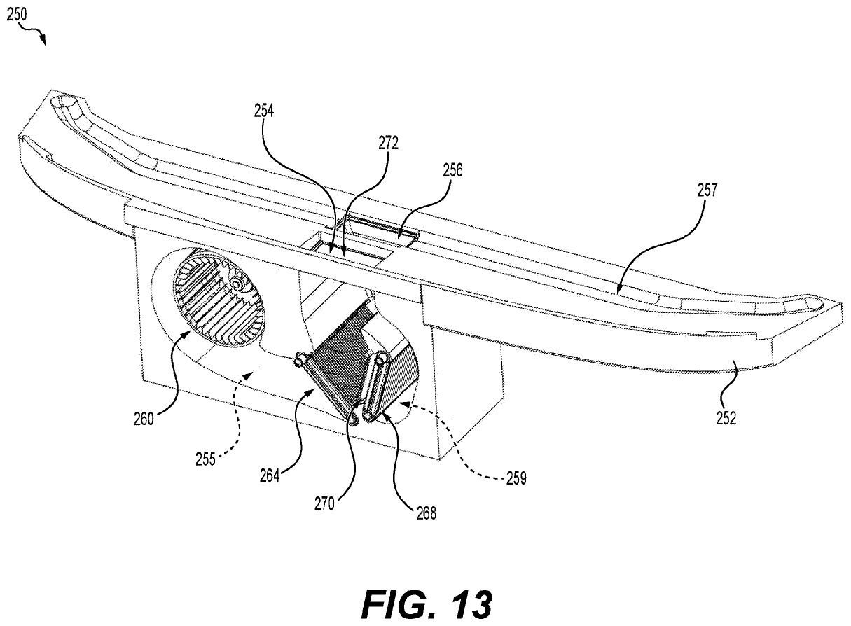

With additional reference to FIGS. 13 to 17, the HVAC unit 250 is connected to the dashboard body 210 and fluidly connected to the airflow passages 220, 225, 230. As is mentioned briefly above, the HVAC unit 250 is arranged to provide environmental air flow to the passenger compartment 130 via the airflow passages 220, 225, 230.

The HVAC unit 250 includes an HVAC housing 252 connected to a bottom side portion of the dashboard body 210. Similarly to the dashboard body 210, the HVAC housing 252 is formed from an expanded polymer. In the present case, the HVAC housing 252 is also formed from EPP, although use of expanded polystyrene or expanded polyurethane are also contemplated. While the HVAC housing 252 is formed separately from the dashboard body 210 in the illustrated embodiment, it is contemplated that some or all of the HVAC housing 252 could be integrally formed with the dashboard body 210, or portions thereof. In at some embodiments, it is also contemplated that portions of the HVAC housing 252 could be formed from different material classes, such as molded plastic. In some embodiments, it is also contemplated that the dashboard body 210 could be connected to a conventional HVAC unit, although it is noted that some advantages of the present arrangement may be lost.

The HVAC unit 250 includes a plurality of HVAC components disposed in the HVAC housing 252. The HVAC components (described below) are arranged for managing and conditioning air flow, including heating and cooling air flow, into the passenger compartment 130 via the plurality of airflow passages 220, 225, 230. In the present embodiment, the HVAC unit 250, and more specifically the HVAC components therein, are powered by the battery system 106. Specifics of the powering arrangement of the HVAC unit 250 could vary, depending on the particular embodiment.

The HVAC housing 252 defines therein an airflow passage 255 in which the HVAC components are disposed, and through which air flows prior to entering the dashboard body 210. An airflow passage branch 259 is also defined in the housing 252, fluidly connected to a main portion of the passage 255. As will be described below, the HVAC unit 250 is configured and arranged to direct or block air flow through the branch 259, depending on cooling and heating operations.

As the HVAC housing 252 is formed from expanded polymer, the airflow passage 255 and the airflow passage branch 259 are directly formed in the housing 252, specifically as voids extending through the housing 252. Other than the passages 255, 259, the volume within the housing 252 is generally filled by the expanded polymer, aiding in maintaining strength and rigidity thereof. As such, the airflow passages 255, 259 235 are uniquely defined and formed by the expanded polymer of the housing 252.

An outlet 254 is a defined in a top surface of the HVAC housing 252, the airflow passage 255 being fluidly connected to the outlet 254. When the HVAC unit 250 is connected to the dashboard body 210, the outlet 254 is aligned with the inlets 221. The outlet 254 is sized and arranged to allow air flowing from the airflow passage 255 and out of the outlet 254 to flow into the inlets 221 for providing air flow to the defroster ducts 220.

Another outlet 256 is a defined in the top surface of the HVAC housing 252, disposed rearward of the outlet 254. A groove 257 is defined in the top surface, extending laterally from the outlet 256, the airflow passage 255 being fluidly connected to the outlet 256 and the groove 257. When the HVAC unit 250 is connected to the dashboard body 210, the outlet 256 and the groove 257 are generally aligned with the inlets 228. The outlet 256 is sized and arranged to allow air flowing from the airflow passage 255 and out of the outlet 256 to flow out along the grooves 257 into the inlets 228 for providing air flow to the demister ducts 225 and the compartment ducts 230. As will be described in more detail, the HVAC unit 250 includes a valve 272, also referred to as an output valve 272, for selectively blocking one of the outlets 254, 256 to selectively control airflow to the inlets 221, 228.

Specifics of the HVAC components are as follows. Operation of the HVAC unit 250 is described in further detail below.

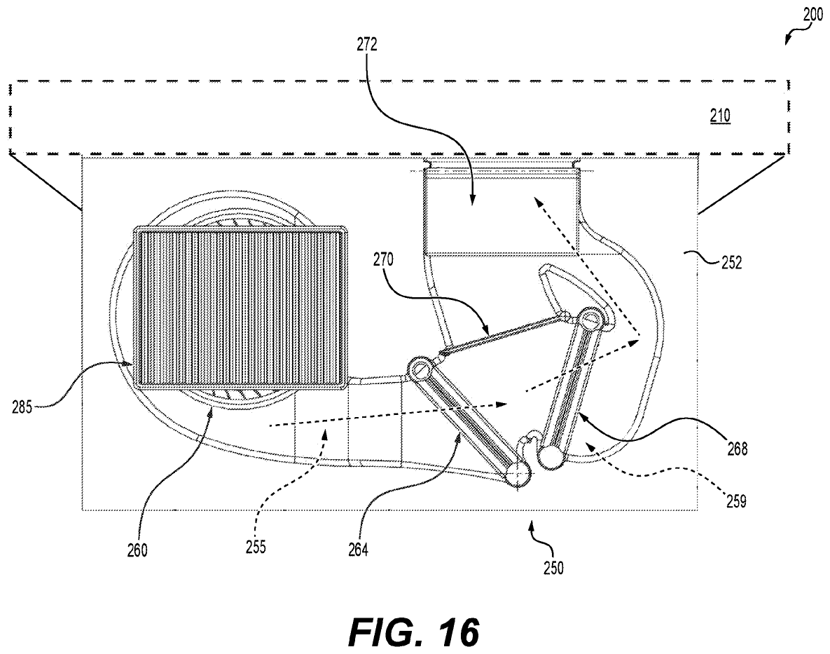

The HVAC components of the HVAC unit 250 include a fan 260 disposed in the airflow passage 255. The fan 260 is configured and arranged to draw air into the airflow passage 255 from the air-intake conduit 280 and drive air flow through the passage 255. The HVAC unit 250 includes a filter 285 disposed between the air-intake conduit 280, specifically the outlet 282 thereof, and the fan 260 (see FIG. 16). The filter 285 filters dust and debris from air flowing through the conduit 280 and into the HVAC unit 250.

The HVAC components include a cooling element 264 disposed in the airflow passage 255, downstream from the fan 260. The cooling element 265, when operating, cools air flowing therethrough. When not operating, the cooling element 265 is arranged to allow airflow therethrough without modifying the air temperature. As can be seen in at least FIG. 13, the cooling element 256 extends across the airflow passage 255, such that all air passing from upstream to downstream of the cooling element 256 must pass through the cooling element 256.

The HVAC components of the HVAC unit 250 include a heating element 268 disposed in the airflow passage 255. The heating element 268 is disposed downstream from the cooling element 256, specifically in the airflow passage branch 259 defined in the housing 252, the branch 259 connecting to the main portion of the airflow passage 255 upstream and downstream from the heating element 268.

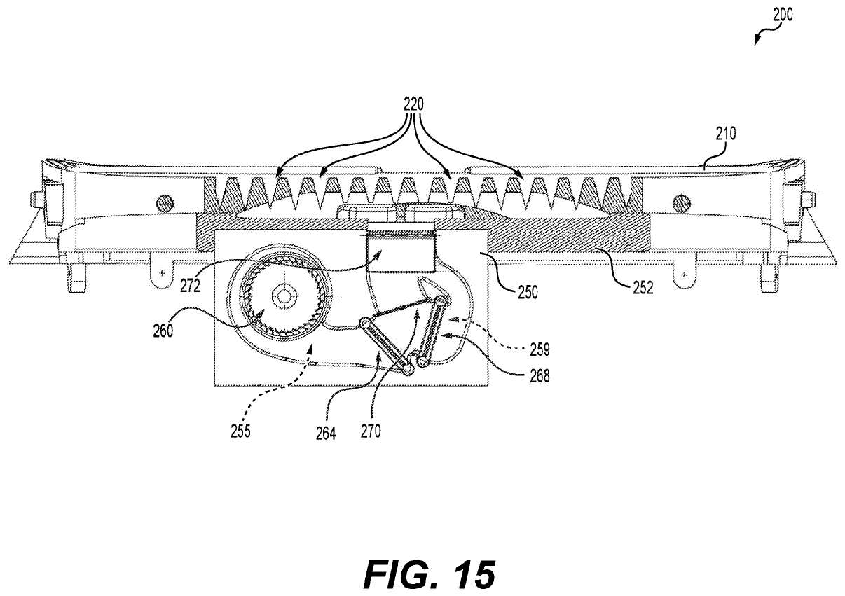

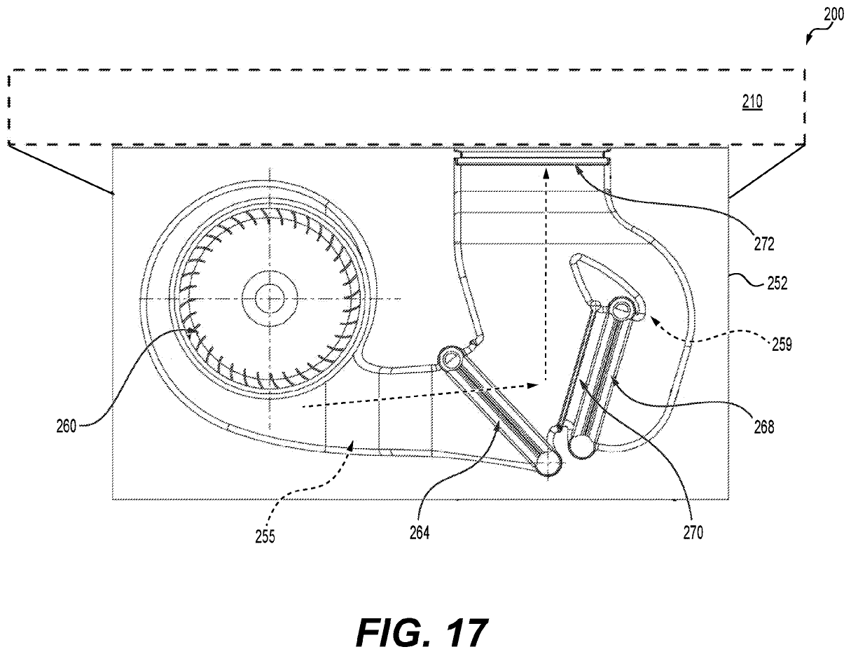

In order to selectively direct (or impede) air through the heating element 268, the HVAC unit 250 includes a temperature-control valve 270. The valve 270 is a servo-actuated pivoting valve, where a blade of the valve 270 selectively blocks the main portion of the passage 255 or the branch 259. In a first position of the valve 270 (FIGS. 13, 17), air flow to the branch 259, and thus the heating element 268, is blocked and airflow is directed to the outlet 254 and/or the outlet 256. See, for instance, the dotted path illustrated in FIG. 17. In a second position of the valve 270 (FIGS. 15, 16), air flow is directed into the branch 259 and through the heating element 268. See, for instance, the dotted path illustrated in FIG. 16.

For internal combustion engine vehicle implementations, the heating element 268 could be implemented as a heat transfer element using engine coolant. In such cases, the heating element 268 would generally be consistently hot and would thus heat air flowing therethrough. When the cooling element 264 is in use to cool, the valve 270 is thus pivoted to the first position to prevent incidental heating of cooled air. For the present embodiment of the electric vehicle 100, the heating element 268 is a resistive element which can be turned off when not in use. In some such embodiments, the valve 270 could thus be removed as air flowing through the heating element 268 would be selectively heated only when desired. By producing the heating by a resistive element in such an embodiment, the tubing and heat exchange structures required for using engine heat to heat air flow can further be omitted, decreasing the overall volume of the HVAC system in such cases. It is contemplated that one or both of the cooling element 264 and the heating element 268 could be replaced by a heat pump.

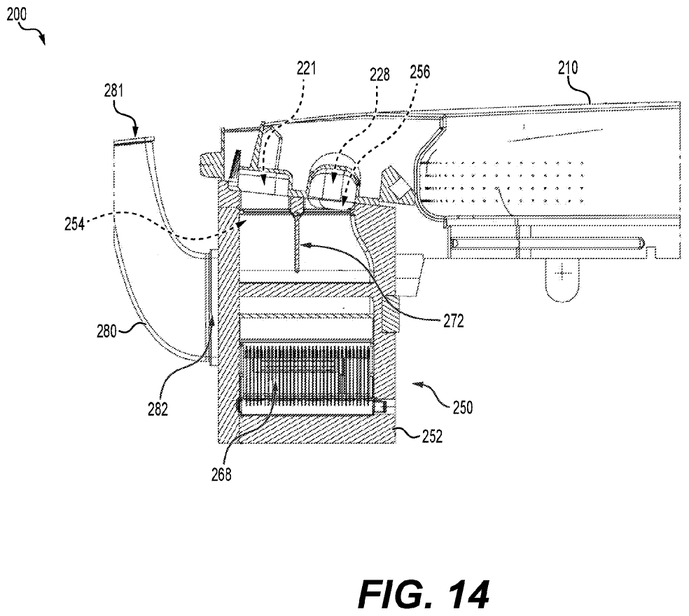

The HVAC components of the HVAC unit 250 further include an output valve 272 for managing air flow from the HVAC housing 252 to the dashboard body 210. Specifically, the output valve 272 selects airflow between the outlet 254 and the outlet 256, such that air is selectively caused to flow through the defroster ducts 220, via the inlets 221, or through the demister ducts 225 and the compartment ducts 230, via the inlets 228. In a first position of the valve 272 (FIG. 13), air flow to the outlet 254 is blocked and air flow to the outlet 256 is permitted. In a second position of the valve 272 (FIG. 17), air flow to the outlet 256 is blocked and air flow to the outlet 254 is permitted. In intermediate positions (FIGS. 14 to 16), air flow is permitted to both outlets 254, 256. It is contemplated that multiple intermediate positions for the valve 272 may be used, for example to direct unequal volumes of air flow through the outlets 254, 256.

During operation of the HVAC unit 250, intake air is pulled into the HVAC housing 252 by the fan 260 and is caused to flow through the airflow passage 255. Air subsequently flows through the cooling element 264. In response to the temperature-control valve 270 being in the first position blocking air flow to the heating element 268, air is directed out of the HVAC housing 252 and into the dashboard body 210. In response to the temperature-control valve 270 being in the second position, air flows through the heating element 268 and is subsequently directed out of the HVAC housing 252 and into the dashboard body 210.

When the valve 272 is in the first position, air flow is directed to a subset of airflow passages, specifically to the demister ducts 225 and compartment ducts 230, via the outlet 256 and the inlets 228. When the valve 272 is in the second position, air flow is directed to another subset of airflow passages, specifically to the defroster ducts 220, via the outlet 25 and the inlets 221. When the valve 272 is an intermediate position, air flows to all of the passages 220, 225, 230, via the outlets 254, 256 and the inlets 221, 228.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A vehicle comprising:
a frame;
a vehicle body formed at least in part by the frame;
a passenger compartment defined at least in part by the vehicle body;
at least one motor supported by the frame;
a plurality of wheels rotationally connected to the frame, at least one wheel of the plurality of wheels being operatively connected to the at least one motor;
a dashboard assembly connected to the frame, the dashboard assembly being at least partially disposed in the passenger compartment, the dashboard assembly comprising:
at least one dashboard body forming at least a portion of a passenger compartment dashboard surface,
a plurality of air-flow passages being defined in the at least one dashboard body; and
a heating, ventilation, and air conditioning (HVAC) unit connected to the at least one dashboard body and fluidly connected to the plurality of air-flow passages, the HVAC unit being arranged to provide environmental air flow to the passenger compartment via the plurality of air-flow passages.

2. The vehicle of claim 1, wherein the plurality of air-flow passages includes an array of defroster ducts defined along a forward portion of the at least one dashboard body.

3. The vehicle of claim 1, wherein the plurality of air-flow passages includes:
a first array of demister ducts defined along a left side portion of the at least one dashboard body; and
a second array of demister ducts defined along a right side portion of the at least one dashboard body.

4. The vehicle of claim 1, wherein the plurality of air-flow passages includes an array of compartment ducts defined along at least a rear side portion of the at least one dashboard body.

5. The vehicle of claim 1, wherein the HVAC unit comprises:
an HVAC housing connected to a bottom side portion of the at least one dashboard body; and
a plurality of HVAC components disposed in the HVAC housing, the plurality of HVAC components being arranged for managing and conditioning air flow into the passenger compartment via the plurality of air-flow passages.

6. The vehicle of claim 5, wherein the HVAC housing and the at least one dashboard body are formed from an expanded polymer.

7.-11. (canceled)

12. The vehicle of claim 1, wherein the dashboard assembly further comprises an air-intake conduit fluidly connected to the HVAC unit.

13. (canceled)

14. The vehicle of claim 1, further comprising a front windshield; and
wherein:
the plurality of air-flow passages includes an array of defroster ducts;
outlets of the array of defroster ducts are defined in a forward portion of the passenger compartment dashboard surface; and
the outlets of the array of defroster ducts are positioned and arranged to deliver air flow to an interior side of the front windshield.

15. The vehicle of claim 14, wherein the array of defroster ducts extends laterally across at least a majority of the at least one dashboard body.

16. The vehicle of claim 1, wherein the at least one dashboard body is formed from an expanded polymer.

17. The vehicle of claim 16, wherein the at least one dashboard body is formed from expanded polypropylene (EPP).

18. The vehicle of claim 16, wherein the at least one dashboard body is formed from one of:
expanded polystyrene; and
expanded polyurethane.

19. The vehicle of claim 16, wherein the plurality of air-flow passages and the passenger compartment dashboard surface are uniquely defined and formed by the expanded polymer of the at least one dashboard body.

20. The vehicle of claim 1, wherein the at least one dashboard body includes:
a center portion extending laterally across the passenger compartment;
a right side portion extending rearward from a right end of the center portion; and
a left side portion extending rearward from a left end of the center portion.

21. The vehicle of claim 1, further comprising:
a left side door pivotally connected to the frame, and
a right side door pivotally connected to the frame; and
wherein:
the plurality of air-flow passages includes a left side array of demister ducts;
outlets of the left side array of demister ducts are defined in a left side portion of the passenger compartment dashboard surface;
the outlets of the left side array of demister ducts are positioned and arranged to deliver air flow near an interior side of the left side door;
the plurality of air-flow passages includes a right side array of demister ducts;
outlets of the right side array of demister ducts are defined in a right side portion of the passenger compartment dashboard surface; and
the outlets of the right side array of demister ducts are positioned and arranged to deliver air flow near an interior side of the right side door.

22. The vehicle of claim 1, wherein:
the plurality of air-flow passages includes an array of compartment ducts;
outlets of the array of compartment ducts are defined in a rear side portion of the passenger compartment dashboard surface; and
the outlet of the array of compartment ducts are positioned and arranged to deliver air flow to the passenger compartment.

23. The vehicle of claim 22, wherein the outlets of the array of compartment ducts are disposed over a width of the passenger compartment.

24.-25. (canceled)

26. The vehicle of claim 1, wherein:
the at least one motor is at least one electric motor;
further comprising a battery system supported by the frame and electrically connected to the electric motor; and
the frame comprises:
a chassis, and
an upper body frame connected to and extending upward from the chassis; and
the dashboard assembly is connected to the upper body frame form.

27.-29. (canceled)

30. The vehicle of claim 1, wherein the at least one dashboard body has a generally flattened-U shape.

31. The vehicle of claim 1, wherein the at least one dashboard body defines a majority of the passenger compartment dashboard surface, the passenger compartment dashboard surface being visible within the passenger compartment to a user of the vehicle.
